(19) United States
(12) Patent Application Publication
(10) Pub. No.: US 2010/0269466 A1
(43) Pub. Date: Oct. 28, 2010

(54) OVAL CAGE COUPLER FOR FILTER CAGES

(76) Inventors: William F. Peshina, North Royalton, OH (US); J. Tyler Headley, Winchester, VA (US)

Correspondence Address: LAW OFFICES OF WILLIAM H. HOLT, 12311 HARBOR DRIVE, WOODBRIDGE, VA, 22192, US

(21) Appl. No.: 12/808,671

(22) PCT Filed: Dec. 17, 2008
(86) PCT No.: PCT/US08/13780

§ 371 Date: Jun. 16, 2010

Related U.S. Application Data
(60) Provisional application No. 61/006,060, filed on Dec. 17, 2007.

(51) Int. Cl. B01D 46/00

(52) U.S. Cl. 55/490

(57) ABSTRACT

An elongated, oval, wire cage for use with a fabric filter (not shown), the cage including a plurality of cage sections (20) and (22) connected together by first and second couplers A and B each of which are provided with spaced, parallel flanges which interact for releasably securing the couplers and cage sections together.

This invention is related to PCT/US2008/011085 having an International Filing Date of 25 Sep. 2008, and entitled “Wire Cage for a Filter Bag”, the details of which are incorporated herein by reference. Also, the invention disclosed herein is entitled to priority dating from U.S. Provisional Application Ser. No. 61/006,060 filed on Dec. 17, 2007.

### BACKGROUND OF THE INVENTION

It is a well known and standard practice for industry to remove particulate matter from a flowing stream of fluid by passing the fluid through a filter that entraps the particulates. More particularly, gases that contain smoke, soot and other particulates created by processes such as combustion of fossil fuels and the like, have been passed through woven or unwoven fabric filters for cleaning such gases prior to further treatment of such gases, or exhausting such gases to the atmosphere. Such filters may be referred to as “fabric filters”, or “bag filters”, and a plurality of such filters are used to provide “dust collectors” or “bag houses”, in which hundreds, or thousands, of such filters are used for filtering huge volumes of contaminated gases.

Heretofore, tubular shaped fabric filters, i.e., filter bags, have been provided with a wire cage placed therein for maintaining the filter in an open condition for allowing gases to pass therethrough while trapping particulates on a surface thereof.

In the past, it has been traditional that such filter bags, and wire cages had various designed lengths in a range of up to approximately 12 to 14 feet (about 3.5 to 4.25 meters), and a large filtering system, i.e., a bag house, might contain between 3,000 and 5,000 filter bags and related cages.

It is known in the art that the wire cages can have various cross sectional shapes such as being circular or oval, either of which has certain desirable attributes. The cage disclosed in the aforementioned PCT Application is circular in cross section while the particular embodiment shown herein has an oval cross section. Similar sectional wire cages, circular and oval, are shown in U.S. Pat. No. 6,905,529 granted to Howard Pipkorn et al., on Jun. 14, 2005.

### SUMMARY OF THE INVENTION

Modern day filter systems, i.e., bag houses containing fabric filters equipped with wire cages, are being designed for having units of filter bags and wire cages with lengths on the order of up to ten (10) meters (32+feet) in length and having, perhaps, as many as 30,000 of such units in a single installation.

It has been deemed advisable, in accord with the present invention, that such foregoing systems include wire cages that are provided in a plurality of sections having a lesser length than a full length of 10 meters for simplifying manufacture, storage, shipping and installation of such cages, and that such sections are provided with means for connecting and/or locking the sections together during installation and for allowing easy separation of, and re-connection of, the cage sections during maintenance operations such as changing and/or repairing worn filter bags.

The present invention successfully provides for connecting together two or more sections of wire cages to provide a desired length and including means for locking and unlocking adjacent sections for forming a rigid, interlocking structure which enhances and retains true, longitudinal straightness of the assembled sections.

### BRIEF DESCRIPTION OF THE DRAWINGS

FIG. 1 is a plan view of a cage coupler for sectional wire filter cages, the coupler having a pair of parallel outwardly turned flanges extending along a length thereof.

FIG. 2 is an elevational view of the coupler shown in FIG. 1.

FIG. 3 is an end view of the coupler shown in FIG. 1.

FIG. 4 is a sectional view of the coupler taken on line 4-4 of FIG. 1 and showing an outwardly turned flange.

FIG. 5 is a sectional view of the coupler taken on line 5-5 of FIG. 1 and showing an outwardly turned flange.

FIG. 6 is plan view of a companion cage coupler for a wire filter cage having a pair of inwardly turned flanges extending along a length thereof for cooperating with the outwardly turned flanges of the cage coupler shown in FIGS. 1-5.

FIG. 7 is an elevational view of the coupler shown in FIG. 6.

FIG. 8 is an end view of the coupler shown in FIG. 6.

FIG. 9 is a sectional view of the coupler taken on line 9-9 of FIG. 6 and showing an inwardly turned flange.

FIG. 10 is a sectional view of the coupler taken on line 10-10 of FIG. 6 and showing an inwardly turned flange.

FIG. 11 is a plan view of the couplers of FIGS. 1 and 6 shown assembled together.

FIG. 12 is a fragmentary showing of two wire cage sections connected together in assembled form through use of a pair of couplers, the details of the couplers being shown in FIGS. 1-5 and 6-10.

FIG. 13 is an end view of the assembled couplers shown in FIG. 11.

FIG. 14 is a sectional view taken on line 14-14 of FIG. 11.

FIG. 15 is a sectional view taken on line 15-15 of FIG. 11.

### DESCRIPTION OF THE PREFERRED EMBODIMENT

The present invention is comprised of a plurality of oval-shaped couplers, indicated by the letters “A” and “B” for connecting wire cage sections 20 and 22 together, as is shown in FIG. 12. Couplers A and B are attached at adjacent ends of cages 20 and 22 for forming an elongated cage to be inserted into a woven or non-woven, elongated, tubular filter bag (not shown) of a type well known in the prior art.

The present invention is particularly related to the coupler elements shown in the drawings on Sheets 1/3 and 2/3, and the manner of assembly shown on Sheet 3/3.

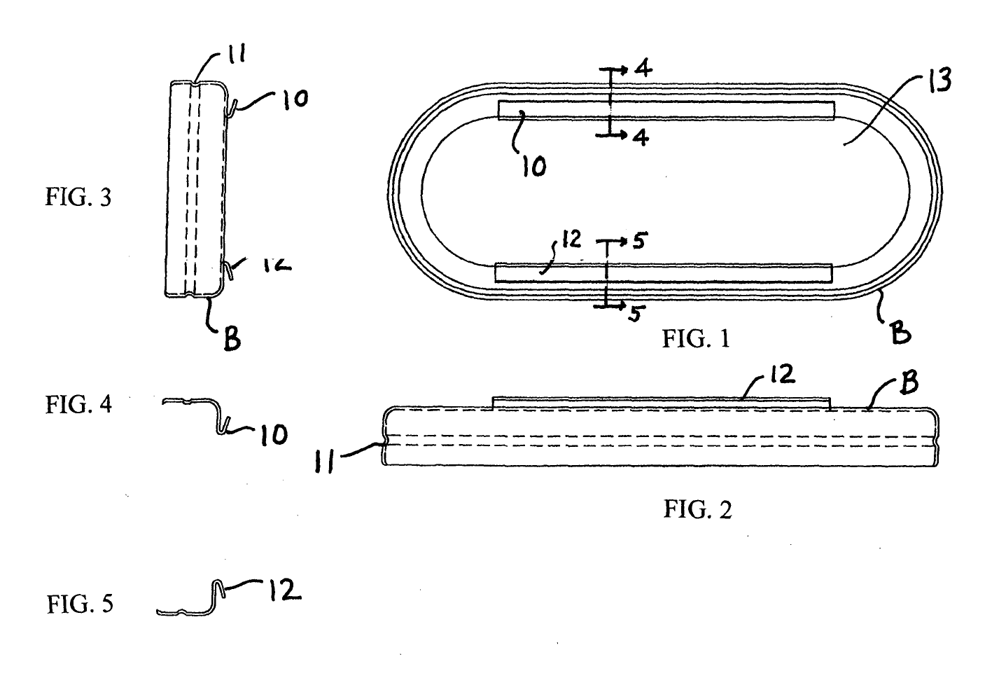

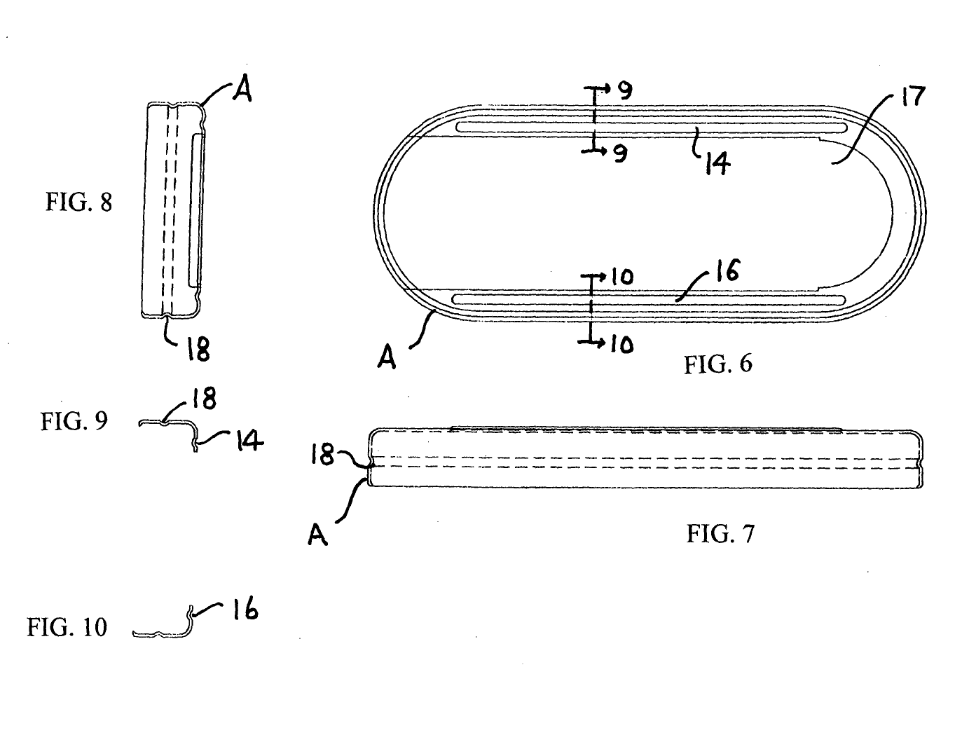

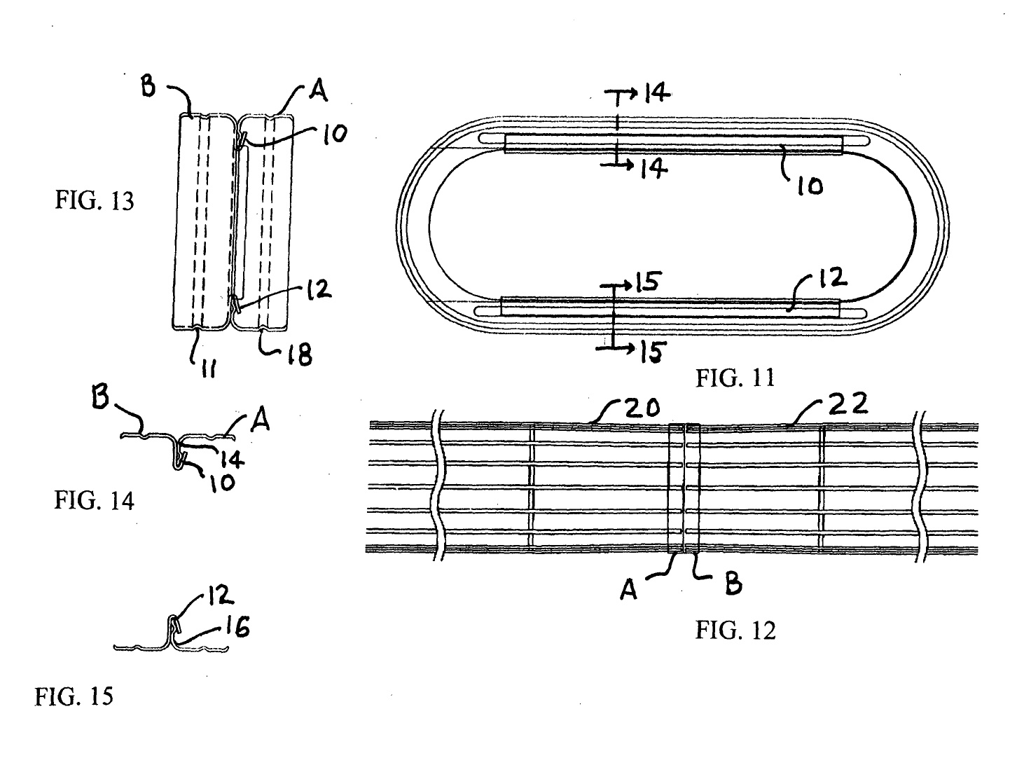

The coupler shown in FIGS. 1-5, identified by the letter “B” includes a pair of radially outwardly extending, arcuate flanges 10 and 12, and a central opening 13 for allowing passage of fluid therethrough. A circumferential groove 11 is formed in coupler B for providing beam strength thereto. The coupler shown in FIGS. 6-10 and identified by the letter “A” includes a pair of radially inwardly directed, bent flanges 14 and 16 and a central opening 17 for allowing passage of fluid therethrough. A circumferential groove 18 is formed in coupler A for providing beam strength thereto. Mating of the two couplers is shown in FIGS. 11 and 13-15 wherein flanges 10 and 12 are shown interlocking with flanges 14 and 16 after couplers A and B are joined together by sliding one longitudinally over the other. This sliding feature distinguishes the present invention over the one shown in previously referred to PCT Application PCT/US2008/011085 wherein the two circular cages are assembled together by rotating one cage relative to the other.

FIG. 12 is a schematic showing of a pair of filter cage sections 20 and 22 being connected together in assembled form by couplers A and B. The wires of section 20 can be secured to coupler A, and the wires of section 22 can be secured to coupler B, by spot-welding.

It is to be understood that the foregoing descriptions are by way of illustration, and the invention is not necessarily limited thereto. Modifications and variations will be apparent from the disclosure and may be resorted to without departing from the spirit of the invention as those of ordinary skill in the art will readily understand. Thus, such variations and modifications are considered to be within the purview and scope of the invention as defined in the following claimed subject matter.

1. An elongated cage comprised of at least a pair of cage sections 20 and 22, a first coupler A attached to an end of cage section 20 and a second coupler B attached to an end of cage section 22, said first coupler and said second coupler comprising means for securing said cage sections together by sliding said first and second couplers together.

2. A cage as defined in claim 1 wherein said first coupler A includes radially inwardly directed flange means 14 and 16 for interfitting with outwardly directed flange means 10 and 12 provided on said second coupler B.

3. A tubular wire cage section 20 and a first oval coupler A attached to an end thereof, said first coupler including a plurality of inwardly directed, longitudinally extending, parallel flange means 14 and 16 for providing a locking assembly.

4. A cage section 20 as defined in claim 3 in combination with a second tubular wire cage section 22, said second cage section having a second oval coupler B attached to an end thereof, said second coupler including reversely bent, outwardly directed, parallel flange means for interlocking with said inwardly directed flange means 14 and 16 on said first oval coupler A.

5. The combination as defined in claim 4 wherein said first and second couplers each include a circumferential groove formed therein for providing beam strength thereto.
